(19) United States
(12) Patent Application Publication
(10) Pub. No.: US 2014/0130116 A1
(43) Pub. Date: May 8, 2014

(54) SYMBOL GESTURE CONTROLS

(71) Applicant: Microsoft Corporation, Redmond, WA (US)

(72) Inventor: Blake Krikorian, Hillsborough, CA (US)

(73) Assignee: Microsoft Corporation, Redmond, WA (US)

(21) Appl. No.: 14/069,085

(22) Filed: Oct. 31, 2013

Related U.S. Application Data
(60) Provisional application No. 61/723,601, filed on Nov. 7, 2012.
(60) Provisional application No. 61/722,658, filed on Nov. 5, 2012.

(51) Int. Cl. H04N 5/44; G06F 3/01

(52) U.S. Cl. CPC H04N 5/4403; G06F 3/017
USPC 725/139

(57) ABSTRACT

Devices in a multi-media environment may be controlled by a controller that accepts gestures as inputs. The gestures may represent characters and/or symbols. These symbol gestures may correspond to different commands based on a current operating mode of a multi-media device in the multi-media environment. A set top box may obtain information relating to the operating mode of the multi-media device, and may provide the information to the controller. The symbol gestures may be translated to a symbol-specific command for the multi-media device by the set top box or the controller. Some gestures may persist across multiple devices or services as corresponding to one command.

### REFERENCE TO RELATED APPLICATIONS

This application claims priority to U.S. Provisional Patent Application No. 61/723,601 filed on Nov. 7, 2012, and entitled “SYMBOL GESTURE CONTROLS,” the entirety of which is incorporated by reference herein, and to U.S. Provisional Patent Application No. 61/722,658 filed on Nov. 5, 2012, and entitled “CONTEXTUAL GESTURE CONTROLS,” the entirety of which is incorporated by reference herein.

### BACKGROUND

Gesture controls may be used with portable devices such as smart phones and tablet computers, as well as other computing devices having touch screens or other mechanisms for capturing user gestures. User gestures include directional and locational contacts with an input interface of a device (e.g., swipes and/or taps on a touch screen). When a user interacts with such devices, gestures may be used to perform operations such as unlocking the devices, playing games, or providing application inputs (e.g., for note taking applications, etc.).

A non-mobile product that utilizes gesture controls is Apple TV® from Apple, Inc. Apple TV® may be used in conjunction with a mobile device from Apple, Inc., such as an iPhone®, iPod Touch®, or an iPad®. For example, an application may be installed on the mobile device that allows a user to provide control signals from the mobile device to the Apple TV® unit. The combination of the application and the portable device allows for some limited use of gestures to control the operation of the Apple TV® unit.

Previous solutions as described above, however, are limited to intra-device control or are limited to use specifically with products from the same manufacturer. Further, previous solutions do not allow for context specific application of gestures (i.e., contextual gesture control) within a given mode of operation, nor do they allow for symbol gesture control of operations.

### SUMMARY

A method for controlling a multi-media device using symbol gesture controls is described herein. In accordance with the method, a symbol gesture representation is received from an input interface of a controller. The symbol gesture representation comprises at least one of an alpha-numeric representation, a punctuation representation, a geometric symbol representation, a geometric shape representation, or an extended character representation. In further accordance with the method, the symbol gesture representation is translated into a multi-media device command. The multi-media device command is then provided to a multi-media device.

In an embodiment, one or more of the steps of the above-described method are performed by a controller. In another embodiment, one or more of the steps of the above-described method are performed by a set top box. In yet another embodiment, one or more of the steps of the above-described method are performed partially by a controller and/or partially by a set top box.

In another embodiment, one or more of the symbol gesture representations are normalized to represent a command across a plurality of different multi-media devices, services, applications, channels and/or content providers.

In a further embodiment, the multi-media device command is provided from a controller to a multi-media device.

In an embodiment, receiving the symbol gesture representations includes receiving the symbol gesture representations by a set top box via an application programming interface (API).

In an embodiment, the multi-media device command comprises at least one of a channel command that causes the multi-media device to display multi-media content of a specified channel, wherein the symbol gesture representation indicates a channel designation for the specified channel, or a mode command that causes the multi-media device to operate in a designated mode.

In another embodiment, the multi-media device command comprises at least one of a channel command that causes the multi-media device to display information associated with content of a specified channel, wherein the symbol gesture representation indicates a channel designation for the specified channel, a menu command that causes the multi-media device to enter a specified menu and display information associated with the specified menu, or a mode command that causes the multi-media device to operate in a designated mode.

In another embodiment, the symbol gesture representation corresponds to a power command. In an embodiment, the multi-media device is in one of a power-up mode or a power-down mode, and the power command causes the multi-media device to enter a power-down mode when in the power-up mode and causes the multi-media device to enter a power-up mode when in the power-down mode.

A system is also described herein. In embodiments, the system is configured to control a multi-media device(s) using symbol gesture controls. The system includes receiving logic, translation logic, and output logic. The receiving logic configured to receive a symbol gesture representation from an input interface of a controller. The symbol gesture representation comprises at least one of an alpha-numeric representation, a punctuation representation, a geometric symbol representation, a geometric shape representation, or an extended character representation. The translation logic is configured to translate the symbol gesture representation into a multi-media device command. The output logic is configured to provide the multi-media device command to the multi-media device.

In an embodiment, one or more of the operating mode logic, the receiving logic, the translation logic, and the output logic are implemented by a controller. In another embodiment, one or more of the receiving logic, the translation logic, and the output logic are implemented by a set top box. In another embodiment, one or more of the receiving logic, the translation logic, and the output logic are implemented partially by the controller and/or partially by the set top box.

In embodiments, a symbol gesture representation is normalized to represent a command across a plurality of different multi-media devices, services, applications, channels and/or content providers.

In an embodiment, the output logic is located in a controller, and is configured to provide a multi-media device command by transmitting the multi-media device command from the controller to a multi-media device.

In an embodiment, the receiving logic is located in a set top box, and includes an application programming interface (API) by which the symbol gesture representation is received.

In an embodiment, the multi-media device command comprises a channel command that causes a multi-media device to display multi-media content of a specified channel, where the symbol gesture representation indicates a channel designation for the specified channel.

In an embodiment, the multi-media device command comprises a mode command that causes the multi-media device to operate in a designated mode.

In another embodiment, the multi-media device command comprises a channel command that causes the multi-media device to display information associated with content of a specified channel, where the symbol gesture representation indicates a channel designation for the specified channel.

In another embodiment, the multi-media device command comprises a menu command that causes the multi-media device to enter a specified menu and display information associated with the specified menu.

In another embodiment, the multi-media device command comprises a mode command that causes the multi-media device to operate in a designated mode.

In an embodiment, the symbol gesture representation corresponds to a power command. In a further embodiment, the multi-media device is in a power-up mode, and the power command causes the multi-media device to enter a power-down mode.

In another embodiment, the multi-media device is in a power-down mode, and the power command causes the multi-media device to enter a power-up mode.

Another system is also described herein. In embodiments, the system is configured to control one or more multi-media devices using symbol gesture controls. The system includes a multi-media device, a set top box, and a controller. The set top box is communicatively coupled to the multi-media device and is configured to obtain information indicative of an operating mode of the multi-media device. The controller includes an application programming interface (API) and is communicatively coupled to the multi-media device and to the set top box. The controller is configured to receive the information from the set top box using the API, and is configured to accept a symbol gesture input associated with a first command of a first operating mode of the multi-media device and associated a second command of a second operating mode of the multi-media device. The symbol gesture input comprises at least one of an alpha-numeric representation, a punctuation representation, a geometric symbol representation, a geometric shape representation, or an extended character representation. The controller is further configured to determine that the multi-media device is operating in the first operating mode based on the received information. The controller is also configured to translate the symbol gesture input into the first command for controlling the multi-media device based at least on the determining that the multi-media device is operating in the first operating mode, and to output the first command for controlling the multi-media device

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the claimed subject matter is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of an example multi-media environment in which symbol gestures are used to control one or more multi-media devices, in accordance with an embodiment.

FIG. 2 illustrates a table of example modes and sub-modes of operation in a multi-media environment, in accordance with an embodiment.

FIG. 3 is a block diagram of an example system for controlling multi-media devices using symbol control gestures, in accordance with an embodiment.

FIG. 4 is a block diagram of an example system for controlling multi-media devices using symbol control gestures that includes a set top box and a controller, in accordance with an embodiment.

FIG. 5 is a block diagram of an example system for controlling multi-media devices using symbol control gestures that includes a set top box and a controller, in accordance with another embodiment.

FIG. 6 depicts a flowchart of a method for controlling a multi-media device using symbol gesture controls, in accordance with an embodiment.

FIG. 7 shows an example computer system that may be used to implement various embodiments described herein.

FIGS. 8 and 9 show example symbol gestures that may be used to implement various embodiments described herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

Further, terminology used herein such as “about,” “approximately,” and “substantially” have equivalent meanings and may be used interchangeably.

Still further, components, devices, and/or the like described herein as “coupled” or “connected” in various manners (e.g., electrically, communicatively, etc.) may be directly or indirectly “coupled” or “connected” in embodiments, although the description herein is not exclusive indirect or direct embodiments unless explicitly and exclusively set forth.

Still further, the use herein of the term “gesture” may be read to include encompass both contextual gestures and symbol gestures (also known as “graffiti” gestures) unless one type of gesture is explicitly excluded by the language herein. For example, an embodiment described as utilizing a “symbol gesture” may also be applicable to a “contextual gesture” or a combination of symbol and contextual gestures. It is contemplated that contextual gestures and symbol gestures are applicable in implementation to the embodiments described herein as would be understood by one skilled in the relevant art(s) having the benefit of this disclosure.

Systems and methods are described herein that control multi-media devices using gesture controls (e.g., symbol control gestures). The embodiments described herein enable control of multi-media environments according to symbol gesture inputs. Such embodiments may allow a user to navigate and control his/her multi-media experience through the use of a reduced number of inputs and/or controller buttons (e.g., using symbol gesture inputs). The embodiments herein also allow for navigation and control of multi-media environments without the need to continuously look at a controller as well as allowing for reduction or elimination of controller backlighting. Embodiments support centralized control of multi-media devices across a variety of devices, applications, content providers, services, channels, manufacturers and/or communication protocols.

Section II below describes exemplary gestures that may be used to control multi-media devices, as described herein. Section III describes example multi-media environments. Section IV describes exemplary contextual control gestures, symbol control gestures, and operating modes that may be used to control multi-media devices. Section V describes exemplary systems for implementing symbol control gestures. Section VI describes various methods that may be implemented for controlling multi-media devices. Section VII describes an example computer system that may be used to implement embodiments described herein. Section VIII provides some concluding remarks.

### II. Example Gestures

In embodiments described herein, gestures may be used as inputs to a controller for controlling one or more multi-media devices in a multi-media environment. The input gestures may correspond to one or more commands. The gesture-to-command mappings may be determined based on a state or mode of operation (also referred to as a context) in which a given multi-media device operates, as discussed in further detail below. Such gestures are considered to be contextual control gestures, at least in that the gesture-to-command mappings may provide different commands for a gesture based on the operating context. Example gesture features include, but are not limited to: directional swipes (multi-directional and up, down, left, right, and/or diagonal combinations thereof), taps (including holds), clicks (including holds), location of directional swipes and/or taps on the controller or gesture input interface, combinations of directional swipes, taps and/or clicks, speed and/or acceleration of directional swipes, length of directional swipes, and/or the like. Gesture inputs may be made by human contact such as a finger swipe, using a stylus, and/or using any other input device or method by which a gesture may be input. In some embodiments, the contextual gestures described in this section may be used in conjunction with the symbol gestures described in the following section and as described herein.

It is contemplated that embodiments described herein with respect to contextual gestures are not so limited, and that symbol gestures may be utilized in such embodiments, as would be understood by a person of skill in the relevant art(s) having the benefit of this disclosure.

In some embodiments, the gesture-to-command mapping may be stored in a database or lookup table of a controller, a set top box, or another device in the multi-media environment. In an embodiment, the database or lookup table may be stored remotely, such as in the cloud. In some embodiments, the gesture-to-command mapping may be preset, or may be programmable and/or configurable by a user.

### III. Example Multi-Media Environments

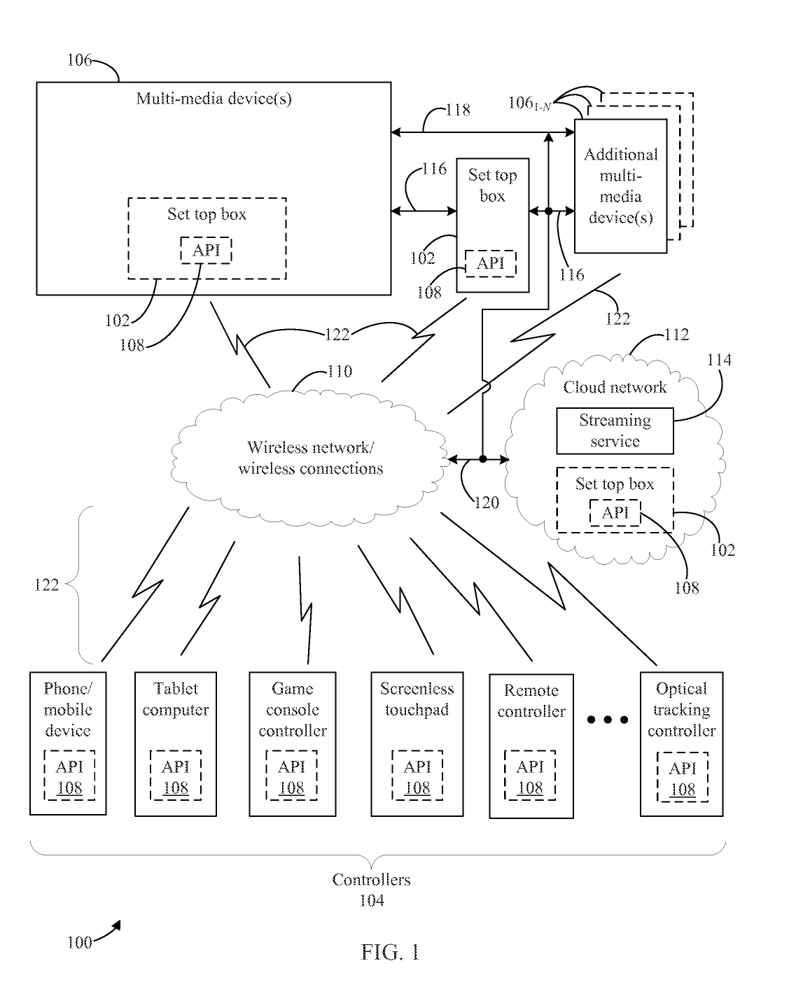

FIG. 1 is a block diagram of an example multi-media environment 100 that includes a set top box (STB) and one or more controllers for controlling multi-media devices using symbol and/or contextual gesture controls. It is noted that multi-media environment 100 is described herein merely by way of example only. Persons skilled in the relevant art(s) will readily appreciate that the symbol and/or contextual gesture control techniques described herein may be implemented in a wide variety of systems other than multi-media environment 100 of FIG. 1.

As shown in FIG. 1, multi-media environment 100 includes a set top box 102, one or more controllers 104, one or more multi-media devices 106, and an API 108. Multi-media environment 100 also includes one or more additional multi-media devices 106_{1-N}, wireless network/wireless connections 110, and a cloud network 112.

As shown in FIG. 1, multi-media device(s) 106 and additional multi-media devices 106_{1-N} are communicatively coupled to set top box 102 via a communication line 116. Multi-media device(s) 106 and additional multi-media devices 106_{1-N} may be connected to each other via a communication line 118 which may comprise a number of individual device connections. Wireless communication links 122 communicatively connect controller(s) 104 with multi-media device(s) 106, additional multi-media devices 106_{1-N}, and set top box 102 in multi-media environment 100. Wireless communication links 122 may connect components and devices of multi-media environment 100 via direct connections and/or via indirect connections, e.g., through wireless network/wireless connections 110, in embodiments. Furthermore, as will be appreciated by those of skill in the relevant art(s), wireless network/wireless connections 110 and wireless communication links 122 are shown in wireless configurations for illustration, and wireless network/wireless connections 110 and wireless communication links 122 may be implemented in a hardwired manner, or a combination of a wireless and a hardwired manner in embodiments. Cloud network 112 may be communicatively coupled via a communication line 120 to set top box 102, multi-media device(s) 106, additional multi-media device(s) 106_{1-N}, and/or wireless network/wireless connections 110. Cloud network 112 may be communicatively coupled via communication line 120, wireless network/wireless connections 110, and/or wireless communication links 122 to one or more controller(s) 104.

In embodiments, communication line 116, communication line 118, communication line 120, and wireless communication links 122 allow for the communication of signals and data between their respectively connected devices and components using any known or future communication protocol related to in-home networks, multi-media applications and devices, data transfers, and/or communications applications.

As illustrated, multi-media environment 100 includes cloud network 112. Cloud network 112 may be the Internet or a portion thereof, a private network, a private cloud network implementation, a media or multi-media service provider, and/or the like. Cloud network 112 may include a streaming service 114 and an implementation of set top box 102. Streaming service 114 may be a streaming service that provides, audio, video, and/or multi-media content from cloud network 112 via communication line 120.

As illustrated, multi-media environment 100 may also include multiple instances of API 108 which may reside in the devices and components of multi-media environment 100, e.g., in set top box 102, in controller(s) 104, in multi-media device(s) 106, additional multi-media device(s) 106_{1-N}, and/or in cloud network 112 (e.g., as exemplified in FIG. 1). Further, an instance of API 108 may be implemented in more than one device or component, e.g., partially in set top box 102 and partially in controller(s) 104. Still further, API 108 may be instantiated once in multi-media environment 100 and accessed/invoked by each component of multi-media environment 100, or may be instantiated once in set top box 102 and once in controller(s) 104, and accessed/invoked by respective sub-components thereof.

In embodiments, API 108 may be configured to implement commands based on gesture inputs or to provide access to logic that performs that function. API 108 may be a custom or standardized API that is configured to (or capable of) interpret the state or mode of a device in multi-media environment 100 (e.g., set top box 102, controller(s) 104, multi-media device(s) 106, additional multi-media device(s) 106_{1-N}, and/or a device(s) in cloud network 112) and/or provide an indication of the state or mode to controller(s) 104. In embodiments, controller(s) may not be related to a device in multi-media environment 100 (e.g., the controller is manufactured by a different company than the device, the controller and the device have one or more communication protocol differences, the controller is not configured to communicate directly with the device, etc.). As such, in embodiments, set top box 102 in conjunction with controller(s) 104 may provide control signals and/or commands for any number of unrelated devices (e.g., devices from different manufacturers) in multi-media environment 100 using a common set of gestures to be applied at the one or more controller(s) 104 in conjunction with API 108. That is, based on the mode or state of a device, a symbol and/or contextual control gesture (e.g., gesture input) may be translated into an appropriate command for the device in the given mode or state. In some embodiments, the control signals and/or commands may be transmitted or provided serially allowing for a broad range of applicability across a number of multi-media devices. In some embodiments, API 108 may include or provide access to a state machine that may be used to implement commands based on gesture inputs.

In embodiments, multi-media device(s) 106 and additional multi-media device(s) 106_{1-N} may include display devices, television signal receivers (e.g., cable TV boxes, satellite receivers, over-the-air antennas, etc.), digital versatile disc (DVD) players, compact disc (CD) players, digital video recorders (DVRs), mobile devices, tablet computers, laptop/desktop computers, music and MP3 players, mono or multichannel audio systems and/or other audio systems, and/or the like. Display devices may include a television, a monitor or computer monitor, a visual projection device, a phone or smartphone or other mobile device, a tablet computer, and/or the like. Devices, components, and/or cloud network 112 may include hardware and/or services for streaming or downloading audio, video, or multi-media content to a user. In embodiments, display devices are considered to be a subset of multi-media devices.

Set top box 102 may be implemented and/or configured in various ways. For instance, in embodiments, set top box 102 may be a stand-alone unit, may be incorporated into a multi-media device such as multi-media device(s) 106 and/or additional multi-media device(s) 106_{1-N} (e.g., a display device), and/or may exist in cloud network 112 as one or more modules, devices, and/or services. Set top box 102 may be configured to provide its state or mode of operation (“mode”) to the one or more controller(s) 104. Providing the state or mode may be performed in response to a request from one or more controller(s) 104, may be periodically performed, and/or may be performed when the state or mode changes. Set top box 102 may also be configured to provide the state or mode of any of the following to the one or more controllers in a manner as described herein: any of multi-media device(s) 106 and/or additional multi-media device(s) 106_{1-N} in multi-media environment 100 and/or a device(s) or service(s) in cloud network 112. Operation states/modes are discussed in further detail below.

As noted above, in embodiments, API 108 may be implemented and/or invoked in set top box 102, wholly or in part.

In embodiments, controller(s) 104 may be one or more of a phone (e.g., a smartphone), an MP3 player, a tablet computer, a laptop computer, a gaming console controller, a screenless touchpad, a remote controller with a touch screen, an optical tracking controller, a handheld device, a mobile device, and/or the like. In embodiments, controller(s) 104 may each include a touch screen or other means that enable a user of controller(s) 104 to input a gesture that corresponds to a mode and/or a command for one or more of the devices (such as multi-media device(s) 106 and/or additional multi-media device(s) 106_{1-N}) in multi-media environment 100. In some embodiments, the user may input the gesture at and/or using a controller, and an indication or representation of the gesture may be transmitted to the set top box or to API 108 within controller(s) 104 where the command may be generated based on the gesture input and/or the device mode.

In embodiments, API 108 may be implemented and/or invoked in controller(s) 104, wholly or in part.

### IV. Example Contextual Control Gestures, Symbol Control Gestures, and Operating Modes

As described in the sections above, the same gesture may correspond to a different command depending on the mode of the device. Additionally, with respect to different multi-media devices, services, applications, channels and/or content providers, a given gesture may correspond to the same command across these different multi-media devices, services, applications, channels and/or content providers. That is, a gesture may be normalized as to its control or associated command in the multi-media environment across a plurality of different multi-media devices, services, applications, channels and/or content providers. For instance, video content may be provided via a Hulu® application, on a Roku® device, from a Netflix® program or service, on an Xbox® device, from a DVR associated with a DirecTV® device or service, and/or the like. In each case, the video content may be viewed by a user on these different video playback systems in a playback mode or playback sub-mode as noted herein. In such modes, a given gesture and its corresponding command(s) may be normalized across the different devices, services, and/or applications such that the given gesture always corresponds to the same command in each of the different devices, services, and/or applications. For instance, in one example, a swipe right gesture may always correspond to a FAST FORWARD command even if the different systems have different individual controls for such a command. Further, the normalized gestures may correspond to different modes of operation as described herein.

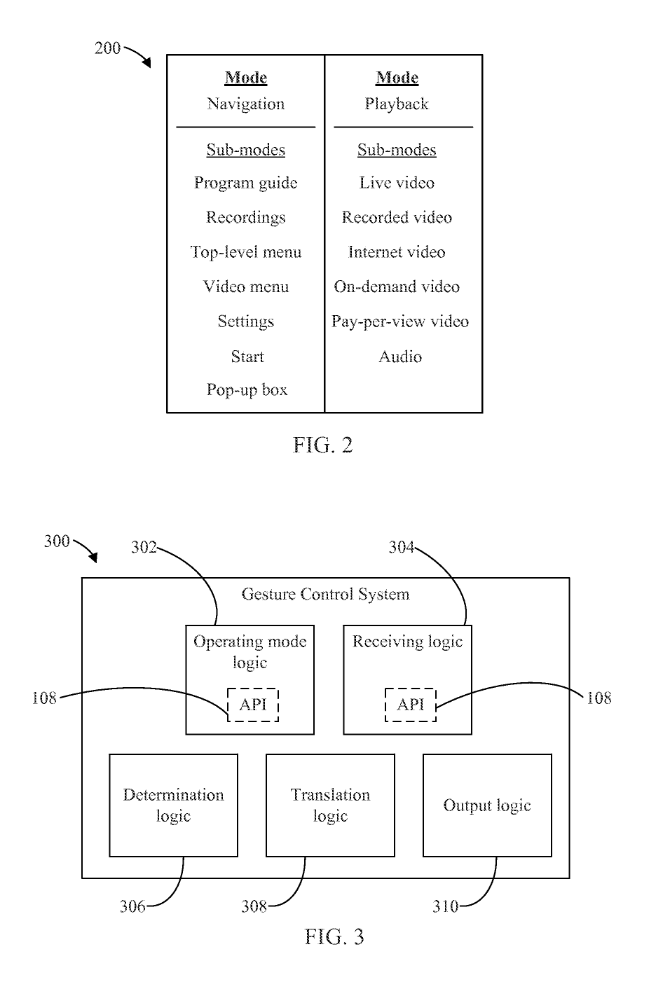

Devices in multi-media environment 100 (e.g., multi-media device(s) 106, additional multi-media device(s) 106_{1-N} and/or a device(s) or service(s) in cloud network 112) may operate in one or more states or modes of operation (“device modes”), in embodiments. For example, FIG. 2 shows example device modes 200 illustrating states or modes of operation for devices in multi-media environment 100. For instance, multi-media devices 106 and/or additional multi-media device(s) 106_{1-N}, as described above, may have two or more operating modes such as a “navigation” mode and a “playback” mode. In a navigation mode, a user may navigate through one or more menus that control the settings of the multi-media devices and one or more menus showing the content and organization thereof in the multi-media devices. In a playback mode, a user may be presented with active audio and/or video. As discussed in further detail in embodiments herein, the same or similar gestures applied at/using a controller by a user may indicate or translate to different commands within the multi-media environment according to the state or mode of a multi-media device (i.e., the context of the multi-media content being displayed or provided). For example, a given gesture in a navigation mode may be interpreted and applied as one command, while the same or similar gesture in a playback mode may be interpreted and applied as a different command based on mode context.

The state or mode of operation of a given device, e.g., playback mode, may be further described in terms of sub-modes of operation (“sub-modes”). FIG. 2 also shows example playback sub-modes of operation in a multi-media environment, according to example embodiments. For example, the playback mode described above may be further categorized into sub-modes such as playback, live video, internes video, recorded video, on-demand video, pay-per-view video, and audio (and/or the like). In one or more of the sub-modes described herein, a gesture (or similar gesture) for one navigation sub-mode may correspond to a command that is similar to, the same as, or different than a command corresponding to another playback sub-mode. For example, in live playback (e.g., a live video sub-mode), a swipe down gesture may correspond to a CHANNEL DOWN command, while in recorded video, a swipe down gesture may correspond to a STOP command. In other embodiments, a swipe right gesture may correspond to a SKIP command during recorded video, while a swipe right gesture may correspond to a NEXT CHAPTER command during on-demand video. It is contemplated, however, that some gesture/command associations may be persistent across two or more playback sub-modes. For example, a gesture for volume control may be the same for one or more of live video, internet video, recorded video, on-demand video, pay-per-view video, audio, etc.

The state or mode of operation (“mode”) of a given device, e.g., navigation mode, may also be further described in terms of sub-modes of operation (“sub-modes”). FIG. 2 also shows example navigation sub-modes of operation in a multi-media environment, according to example embodiments. For example, the navigation mode described above may be further categorized into sub-modes such as a program guide, a recording menu, a top-level menu, a video menu, a settings menu, a start menu, and a pop-up dialog box (and/or the like). In one or more of the sub-modes described herein, a gesture (or substantially similar gestures) for one navigation sub-mode may correspond to a command that is similar to, the same as, or different than a command corresponding to another navigation sub-mode. For example, in the program guide, a swipe left gesture may correspond to a MOVE LEFT command, while in the recording list, a swipe left gesture may correspond to a DELETE command. In another example, in the program guide, a swipe right gesture may correspond to a MOVE RIGHT command, while in the recording list, a swipe left gesture may correspond to a PLAY command. It is contemplated, however, that some gesture/command associations may be persistent across two or more navigation sub-modes. For example, a gesture for selection of an item (e.g., a tap or double tap gesture, or a click or double click gesture) may be the same for one or more of a program guide, a recordings list, menu/settings, and a video menu (and/or the like).

In the embodiments described herein, symbol gestures may be used as inputs to a controller for controlling one or more multi-media devices (e.g., multi-media device(s) 106, additional multi-media device(s) 106_{1-N} and/or a device(s) or service(s) in cloud network 112) in a multi-media environment (multi-media environment 100). Input symbol gestures may correspond to one or more commands. The gesture-to-command mappings may be determined based upon the state or mode of operation (i.e., the context) in which a given multi-media device operates in embodiments, as discussed in further detail herein. Example symbol gesture features include, but are not limited to: alpha-numeric representations (e.g., letters, numbers, etc.), punctuation representations, text editing/formatting representations, arithmetic operator representations, monetary symbol representations, geometric shape/symbol representations, ASCII/Unicode character representations, custom created gestures (e.g., free-form gestures, user- and/or developer-created gestures, etc.), and/or the like.

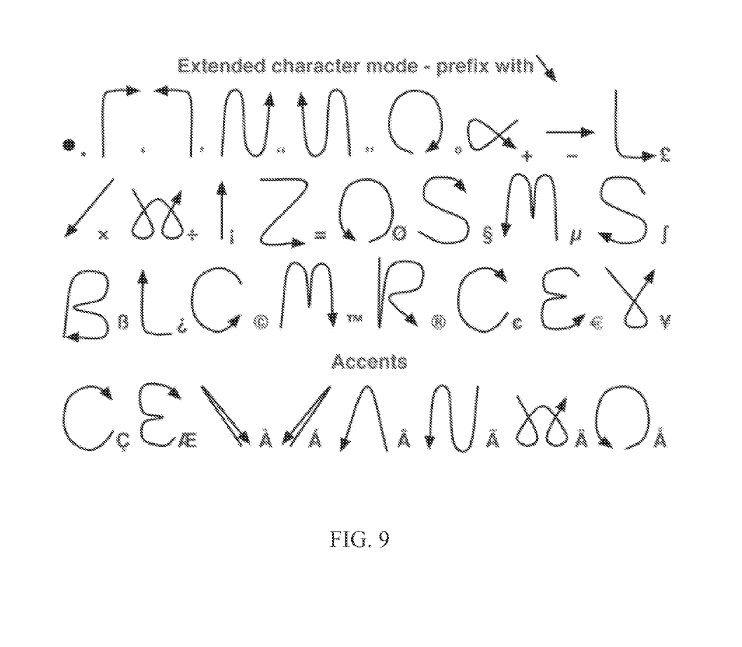

For example, FIGS. 8 and 9 show example sets of symbol gestures. The depicted sets of symbol gestures are not exhaustive, and symbol gestures may represent characters symbols, shapes, and/or the like, as described herein or as would be understood by a person of skill in the relevant art(s) having the benefit of this disclosure. As shown in FIG. 8, symbol gestures may represent alpha-numeric characters and punctuation characters. As shown in FIG. 9, symbol gestures may represent additional characters such as non-letter and/or non-number characters, monetary characters, accented characters, arithmetic operators, etc. A given symbol gesture representation may correspond to commands for multi-media devices in a given mode of operation or across more than one mode of operation.

For example, as shown in FIG. 8, the following symbol gesture [symbol] G, represents the English letter ‘G’ and may correspond to a GUIDE command (or GUIDE button on a standard remote controller) that, when input by a user, presents the user with a guide function or menu for a given multi-media device. By allowing the user to input a command via a corresponding gesture, the user need not look down from his/her viewing experience in order to find the GUIDE button.

In another example, as shown in FIG. 8, the following symbol gesture [symbol] M, represents the English letter ‘M’ and may correspond to a MENU command (or MENU button on a standard remote controller) that, when input by a user, presents the user with a menu function or menu display for a given multi-media device. By allowing the user to input a command via a corresponding gesture, the user need not look down from his/her viewing experience in order to find the MENU button.

In yet another example, as shown in FIG. 8, the following combination of symbol gestures [symbol] H [symbol] B [symbol] O represents the English letters ‘H’, ‘B’, and ‘O’ and may correspond to a command that, when input by a user, changes the viewing channel to the HBO® network for a given multi-media device. By allowing the user to input a command via a corresponding gesture combination, the user need not look down from his/her viewing experience in order to input the desired viewing channel.

Similarly, as shown in FIG. 8, the following combination of symbol gestures [symbol] 2 [symbol] 4 [symbol] represents the numerals ‘2’, ‘4’, and ‘5’ and may correspond to a command that, when input by a user, changes the viewing channel to channel 245 for a given multi-media device. By allowing the user to input a command via a corresponding gesture combination, the user need not look down from his/her viewing experience in order to input the desired viewing channel.

In still another example, as shown in FIG. 9, the following symbol gesture [symbol] + represents the character ‘+’ and may correspond to a POWER command that, when input by a user, powers a given multi-media device OFF or ON. That is, if the multi-media device is in a power-up mode (e.g., the device is “on”), the POWER command puts the multi-media device in a power-down mode (e.g., the device is “off,” “asleep,” or in “stand-by”). By allowing the user to input a command via a corresponding gesture combination, the user need not look down from his/her viewing experience in order to turn a device OFF or ON.

A given symbol gesture and its corresponding command(s) may be normalized across the different devices, services, and/or applications such that the given symbol gesture corresponds to the same command in each of the different devices, services, and/or applications. For instance, in the example depicted immediately above, symbol gesture that represents the character ‘+’ and corresponds to a POWER even if the different systems have different individual controls for such a command. Further, the normalized gestures may correspond to different modes of operation as described herein.

It should be noted that the example symbol gestures described in this section are illustrative in nature, and that mappings of symbol gestures to one or more commands may be made in any combination of symbol gesture to command as desired by a designer or a user. Still further, alternative symbol gestures are also contemplated for the described character/symbol representations—that is, the symbol gestures shown and described herein may be modified, substituted, or exchanged in any manner as desired by a designer or a user.

Accordingly, symbol gestures may correspond to commands that affect operations of multi-media devices without requiring the user to look for buttons on a controller.

It is contemplated that embodiments described herein with respect to symbol gestures are not so limited, and that symbol and/or contextual gestures may be utilized in such embodiments, as would be understood by a person of skill in the relevant art(s) having the benefit of this disclosure.

In some embodiments, the symbol gesture-to-command mappings may be stored in a database or a lookup table of a controller, a set top box, or another device in the multi-media environment. In some embodiments, the symbol gesture/command mapping may be preset, or may be programmable and/or configurable by a user.

### V. Example Systems for Implementing Symbol Control Gestures

This section describes exemplary systems for implementing symbol control gestures as described herein.

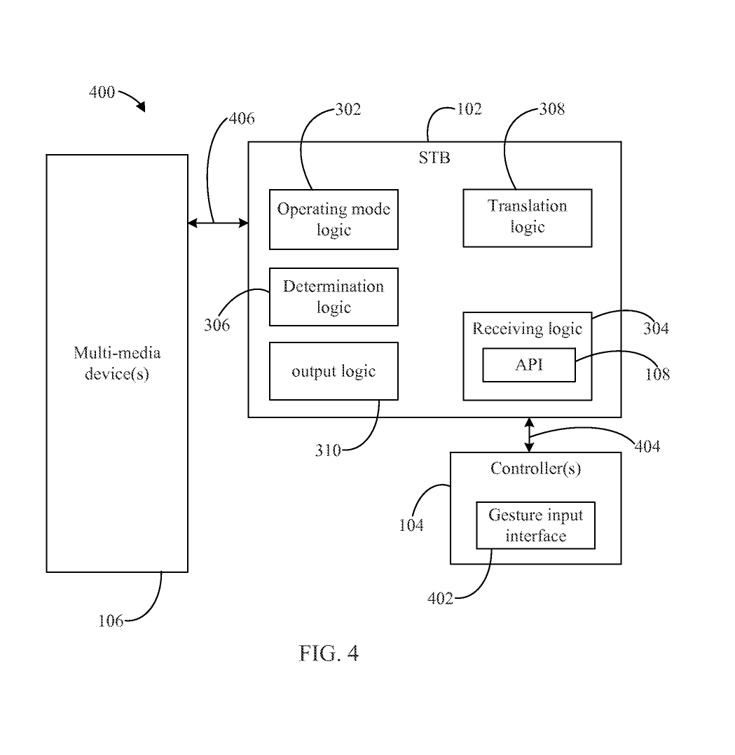

For example, FIG. 3 shows a block diagram of a gesture control system 300 that includes logic for controlling multi-media devices using symbol gesture controls. It is noted that gesture control system 300 is described herein merely by way of example only. Persons skilled in the relevant art(s) will readily appreciate that the symbol and/or contextual gesture control techniques described herein may be implemented in a wide variety of systems other than gesture control system 300 of FIG. 3.

As shown in FIG. 3, gesture control system 300 includes operating mode logic 302, receiving logic 304, determination logic 306, translation logic 308, and output logic 310. Each of these logic components may be communicatively coupled with the other logic components shown in FIG. 3, and each logic component may be communicatively coupled with one or more external devices, external services, and/or external logic components (not shown). Furthermore, each logic component may be implemented as hardware, firmware, and/or software, or any combination thereof. For instance, one or more of operating mode logic 302, receiving logic 304, determination logic 306, translation logic 308, and output logic 310 may be implemented as a software module in gesture control system 300 that is stored in a memory and executed by a processing device (not shown but described in detail below).

In embodiments, operating mode logic 302 may be configured to obtain information indicative of an operating mode of a multi-media device. Operating mode logic 302 may be implemented in set top box 102, in controller(s) 104, and/or partially in both set top box 102 and controller(s) 104. In embodiments, set top box 102 and controller(s) 104 obtain information indicative of an operating mode of a multi-media device using operating mode logic 302 via communication lines and/or wireless communication links with multi-media devices (e.g., multi-media device(s) 106 and/or additional multi-media device(s) 106_{1-N}) as described with respect to FIG. 1 above.

Operating mode logic 302 may include an instance of API 108 as described above with respect to FIG. 1 and in the following section. Operating mode logic 302 may invoke API 108 to obtain the information. Operating mode logic 302 and API 108 may include logic configured to obtain information received in a transmission or signal in accordance with known or future data transfer protocols. The information may be obtained using a camera or optical controller, or from a signal provided by a multi-media device.

In embodiments, operating mode logic 302 may be updated by a user, e.g., via programming or firmware updates, to obtain information using newly adopted protocols.

In embodiments, receiving logic 304 may be configured to receive one or more control gesture representations associated with one or more first commands of a first operating mode of the multi-media device and one or more second commands of a second operating mode of the multi-media device. In embodiments, receiving logic 304 may receive control gesture representations based on a gesture input that a user applies to a gesture input interface as described below. Receiving logic 304 may be implemented in set top box 102, in controller(s) 104, and/or partially in both set top box 102 and controller(s) 104.

Receiving logic 304 may include an instance of API 108 as described above with respect to FIG. 1 and in the following section. Receiving logic 304 may invoke API 108 to receive the one or more control gesture representations. Receiving logic 304 and API 108 may include logic configured to recognize and receive known or future control gesture representations, and in embodiments, receiving logic 304 may be updated by a user, e.g., via programming or firmware updates, to recognize received control gesture representations using newly adopted gestures (e.g., custom gestures created by a user).

Determination logic 306 may be configured to determine that the multi-media device is operating in an operating mode based on the obtained information in embodiments. For instance, determination logic 306 may determine that a multi-media device is in a playback mode or a navigation mode (or any sub-mode thereof) as described herein based on state or mode information received by operating mode logic 302. In embodiments, the operating mode may be determined by comparing the obtained information to entries in a database or a lookup table (not shown). Determination logic 306 may be implemented in set top box 102, in controller(s) 104, and/or partially in both set top box 102 and controller(s) 104.

In embodiments, translation logic 308 may be configured to translate the one or more control gesture representations into commands based at least on the determining that the multi-media device is operating in the first operating mode. Translation logic 304 may include an instance of API 108 as described above with respect to FIG. 1 and in the following section. Translation logic 304 may invoke API 108 to translate the one or more control gesture representations into one or more respective commands. For instance, if a multi-media device is in a playback mode or sub-mode, a control gesture representation may be translated to a command associated with the playback mode, but if the multi-media device is in a navigation mode or sub-mode, the same control gesture representation may be translated to a command associated with the navigation mode. In a non-limiting example, it may be determined that a multi-media device is operating in playback mode and further in a recorded video sub-mode. A swipe right gesture may correspond to a SKIP command during recorded video. However, if the mode changes to navigation in a program guide sub-mode, a swipe right gesture may correspond to a MOVE RIGHT command. In another example, a swipe right gesture may correspond to a SKIP command while in the playback mode and a recorded video sub-mode, while a swipe right gesture may correspond to a NEXT CHAPTER command while in the playback mode and in an on-demand video sub-mode. In yet another example, in the program guide sub-mode of the navigation mode, a swipe right gesture may correspond to a MOVE RIGHT command, while in the recording list sub-mode, a swipe left gesture may correspond to a PLAY command.

In embodiments, a symbol gesture that represents the numerals ‘2’, ‘4’, and ‘5’ (as described in the previous section) may correspond to, and be translated to, a command that enables the viewing channel to be changed to channel 245 for a given multi-media device in a playback mode. In a navigation mode, a symbol gesture that represents the numerals ‘2’, ‘4’, and ‘5’ (as described in the previous section) may correspond to, and be translated to, a command that enables the information associated with the multi-media content of channel 245 for a given multi-media device to be displayed.

In embodiments, a symbol gesture that represents the letter ‘M’ (as described in the previous section) may correspond to, and be translated to, a command that at causes the multi-media device to operate in a menu mode or sub-mode. A symbol gesture that represents the letter ‘X’ (similar to an ‘M’ gesture as described in the previous section) may correspond to, and be translated to, a command that at causes the multi-media device to exit in a mode or sub-mode and return to a previous mode or sub-mode.

In embodiments, a lookup table or database may be used to translate the one or more symbol and/or contextual control gesture representations into commands. The lookup table or database may be stored locally, e.g., in any modules and/or devices described above or in exemplary processor-based computer system 700 described below. In some embodiments, the lookup table or database may be stored remotely on a network or on the Internet (e.g., in cloud network 112).

Translation logic 306 may be implemented in set top box 102, in controller(s) 104, and/or partially in both set top box 102 and controller(s) 104.

Output logic 310 may be configured to output one or more commands, in embodiments. For example, output logic may receive one or more commands from translation logic 308 and output the command(s) to one or more of set top box 102, controller(s) 104, multi-media devices 106, additional multi-media device(s) 106_{1-N}, and/or modules, devices, and/or services in cloud network 112. Output logic 310 may be implemented in set top box 102, in controller(s) 104, and/or partially in both set top box 102 and controller(s) 104.

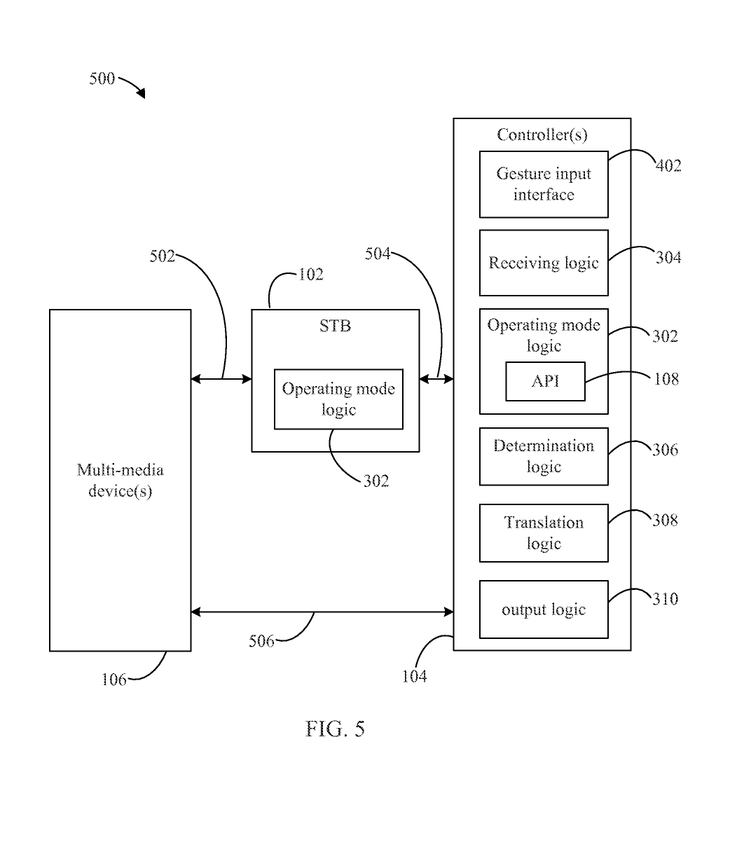

FIG. 4 shows a block diagram of an example gesture control system 400 in which gesture control system 300 is substantially implemented in a set top box (e.g., set top box 102). That is, gesture control system 400 as illustrated may be a further embodiment of gesture control system 300. It is noted that gesture control system 400 is described herein merely by way of example only. Persons skilled in the relevant art(s) will readily appreciate that the symbol and/or contextual gesture control techniques described herein may be implemented in a wide variety of systems other than gesture control system 400 of FIG. 4.

As shown in FIG. 4, gesture control system 400 includes set top box 102, controller(s) 104, and multi-media device(s) 106. Set top box 102 is communicatively coupled to controller(s) 104 via communication line 404, and is communicative coupled to multi-media device(s) 106 via communication line 406.

Set top box 102 includes operating mode logic 302, receiving logic 304, API 108, determination logic 306, translation logic 308, and output logic 310 as described above with respect to FIG. 3. Each of these logic components may be communicatively coupled with the other logic components shown in FIG. 4, and each logic component may be communicatively coupled with one or more other devices, services, and/or logic components (e.g., controller(s) 104 and sub-components thereof, and multi-media device(s) 106 and sub-components thereof). Furthermore, each logic component may be implemented as hardware, firmware, and/or software, or any combination thereof. For instance, one or more of operating mode logic 302, receiving logic 304, API 108, determination logic 306, translation logic 308, and output logic 310 may be implemented as a software module in gesture control system 400 that is stored in a memory and executed by a processing device (not shown but described in detail below).

Controller(s) 104 may include a gesture input interface 402. Gesture input interface 402 may comprise one or more of a touch screen, a touch pad, a click pad, and/or the like. Gesture input interface 402 is configured to allow a user to input a gesture to controller(s) 402 using, e.g., a finger, a stylus, and/or the like. As described in embodiments, the input gesture may correspond to one or more commands associated with one or more operating modes and/or sub-modes of multi-media devices. Gesture input interface 402 may provide a representation of the input gesture to one or more services, devices and/or components described herein directly or indirectly.

For example, gesture input interface 402 may provide a gesture representation of the input gesture via communication line 404 to receiving logic 304 via API 108 of set top box 102 in FIG. 4. In embodiments, receiving logic 304 may receive the control gesture representation from one or more controllers (e.g., controller(s) 104) that may be provided by different companies and/or manufacturers, and may identify the control gesture representation regardless of the protocol used to provide it, e.g., by using a lookup table or database for identification. Operating mode logic 302 obtains information indicative of an operating mode of multi-media device(s) 106 and provides the information to determination logic 306. Determination logic 306 determines the operating mode of multi-media device(s) 106 (e.g., as described herein). The identified control gesture representation may be provided to translation logic 308 along with the determined operating mode. Translation logic 308 may translate the control gesture representation to a command based at least on the determined operating mode. The operating mode-appropriate command may be provided to output logic 310, and output logic 310 may output the command to multi-media device(s) 106.

In alternate embodiments, output logic 310 may output the command to controller(s) 104, and controller(s) 104 may wirelessly transmit the command to multi-media device(s) 106.

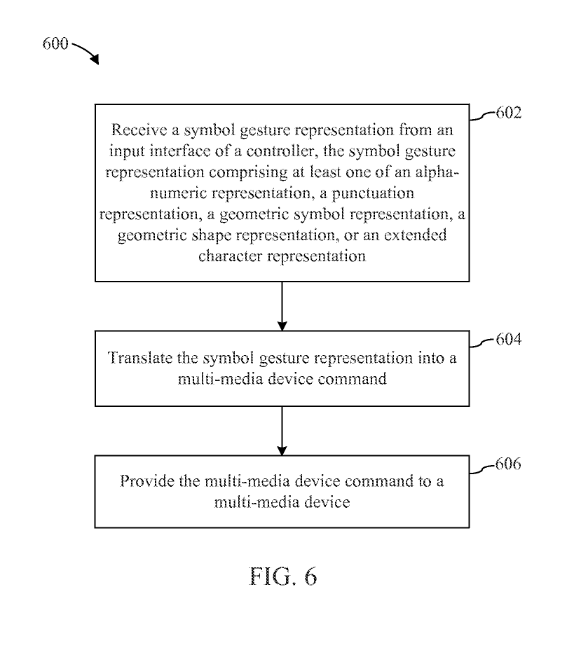

FIG. 5 shows a block diagram of an example gesture control system 500 in which gesture control system 300 is substantially implemented in a controller (e.g., controller(s) 104). That is, gesture control system 500 as illustrated may be a further embodiment of gesture control system 300. It is noted that gesture control system 500 is described herein merely by way of example only. Persons skilled in the relevant art(s) will readily appreciate that the symbol and/or contextual gesture control techniques described herein may be implemented in a wide variety of systems other than gesture control system 500 of FIG. 5.

As shown in FIG. 5, gesture control system 500 includes set top box 102, controller(s) 104, and multi-media device(s) 106. Set top box 102 is communicatively coupled to controller(s) 104 via a communication line 504, and is communicatively coupled to multi-media device(s) 106 via a communication line 502. Controller(s) 104 and multi-media device(s) 106 may be communicatively coupled via a communication line 506.

Set top box 102 may include operating mode logic 302, as described above with respect to FIG. 3. Operating mode logic 302 may be communicatively coupled with the other logic components shown in FIG. 4, and with one or more other devices, services, and/or logic components (e.g., controller(s) 104 and sub-components thereof, and multi-media device(s) 106 and sub-components thereof). For example, operating mode logic 302 in set top box 102 of FIG. 5 may obtain information indicative of an operating mode of multi-media device(s) 106, and may provide the information to controller(s) 104 and/or operating mode logic 302 in controller(s) 104 when invoked to do so via API 108. Furthermore, operating mode logic 302 may be implemented as hardware, firmware, and/or software, or any combination thereof. For instance, operating mode logic 302 may be implemented as a software module in gesture control system 500 that is stored in a memory and executed by a processing device (not shown but described in detail below).

Controller(s) 104 may include gesture input interface 402, as described in FIG. 4, and operating mode logic 302, receiving logic 304, API 108, determination logic 306, translation logic 308, and output logic 310 as described above with respect to FIG. 3. Each of these logic components may be communicatively coupled with the other logic components shown in FIG. 5, and each logic component may be communicatively coupled with one or more other devices, services, and/or logic components (e.g., set top box 102 and sub-components thereof, and multi-media device(s) 106 and sub-components thereof). Furthermore, each logic component may be implemented as hardware, firmware, and/or software, or any combination thereof. For instance, one or more of operating mode logic 302, receiving logic 304, determination logic 306, API 108, translation logic 308, and output logic 310 may be implemented as a software module in gesture control system 500 that is stored in a memory and executed by a processing device (not shown but described in detail below).

Gesture input interface 402 may comprise one or more of a touch screen, a touch pad, a click pad, and/or the like. Gesture input interface 402 is configured to allow a user to input a gesture to controller(s) 402 using, e.g., a finger, a stylus, and/or the like. As described in embodiments, the input gesture may correspond to one or more commands associated with one or more operating modes and/or sub-modes of multi-media devices. Gesture input interface 402 may provide a representation of the input gesture to one or more services, devices and/or components described herein.

For example, gesture input interface 402 may provide a gesture representation of the input gesture to receiving logic 304 of controller(s) 104 in FIG. 5. Operating mode logic 302 obtains information indicative of an operating mode of multi-media device(s) 106 (e.g., via API 108) and provides the information to determination logic 306. Determination logic 306 determines the operating mode of multi-media device(s) 106 (e.g., as described herein). The identified control gesture representation may be provided to translation logic 308 along with the determined operating mode. As described above with respect to FIG. 3, translation logic 308 may translate the control gesture representation to a command based at least on the determined operating mode. The operating mode-appropriate command may be provided to output logic 310 of gesture control system 400, and output logic 310 may output the command to multi-media device(s) 106.

### VI. Example Methods of Operation

This section describes various methods that may be implemented by devices and/or systems to control multi-media devices using symbol and/or contextual control gestures as described herein.

As noted above, the same or similar gestures may indicate or translate to different commands within the multi-media environment according to the state or mode of operation (“mode”) of a multi-media device (i.e., the context of the multi-media content being displayed or provided). In some embodiments, a set top box (e.g., set top box 102) and/or one or more controllers (e.g., controller(s) 104) may automatically switch a gesture-to-command mapping based on the mode or provided context of a given device. Such switching may be implemented using an API (e.g., API 108) or state machine as described above. For example, when a user selects a recorded video to watch in the navigation mode, the mode automatically switches to the playback mode when the recorded video begins to play. Similarly, when the playback of the recorded video ends and the multi-media device ends playback and provides a navigation menu without the need for input from the user, the mode automatically switches from the playback mode to the navigation mode.

The API and/or the state machine may accomplish the described automatic switching by monitoring the signal stream from one or more of the multi-media devices in the multi-media environment in embodiments. In an embodiment, an optical monitor (e.g., a camera or optical controller) may be used in conjunction with a set top box and/or a controller to monitor the state or mode of a given multi-media device (e.g., by monitoring one or more display devices). In embodiments, the set top box may obtain information indicative of an operating mode of a multi-media device via communication connections between the set top box and one or more multi-media devices. In accordance with an embodiment, the set top box may have a pass signal through mechanism or module that allows for data relating to the state or mode of a multi-media device to pass to the controller such that the controller obtains the device state/mode information. In such embodiments, the controller may operate as an intermediary set top box and may perform some or all of the operations of a set top box. In these embodiments, the controller may interface with the optical monitor to determine when pop-up dialog boxes occur.

Pop-up dialog boxes may also trigger a switch in state or mode (i.e., a change in context). In some embodiments, pop-up dialog boxes may be considered part of, or a sub-mode of, the navigation mode. A change in context upon the occurrence of a pop-up dialog box may allow for interacting with the pop-up dialog box without affecting the underlying operational mode. In some embodiments, a specific gesture or combination of gestures may allow a user to control the underlying operational mode before interacting with the pop-up dialog box. For example, a user may use a specific gesture to issue a PAUSE command for underlying live or recorded video when a pop-up dialog box appears.

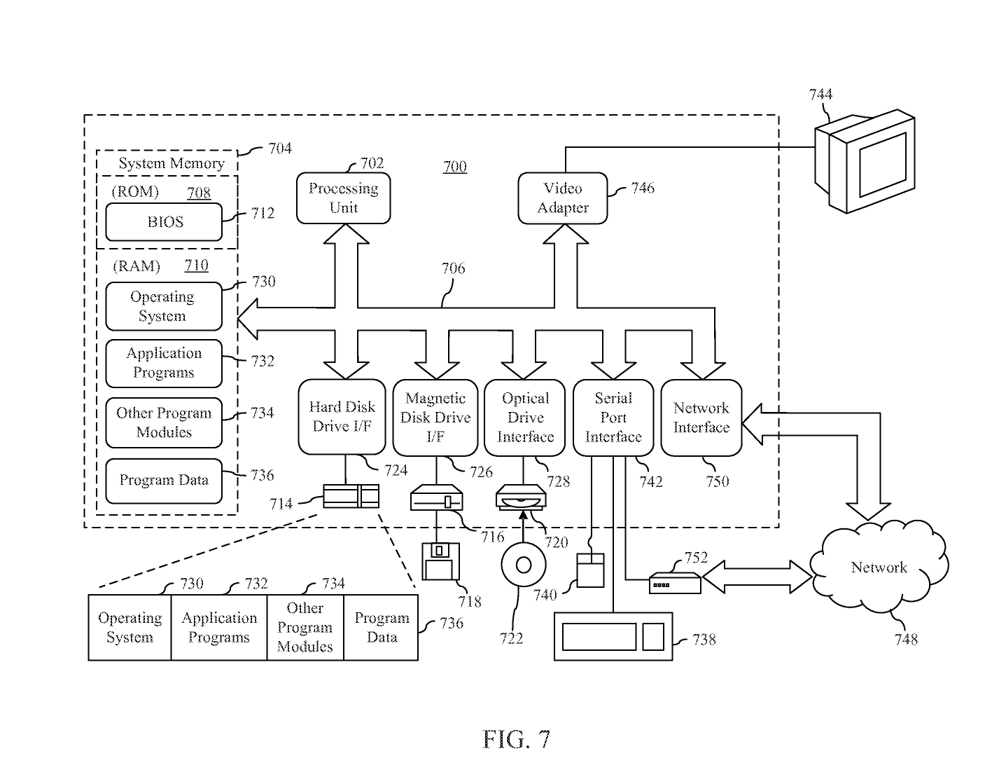

FIG. 6 depicts a flowchart 600 of a method for controlling a multi-media device using symbol gesture controls, in accordance with an embodiment. The method of flowchart 600 may be performed, for example, by set top box 102, controller(s) 104, and API 108 as described above in reference to FIG. 1, by gesture control system 300 as described above in reference to FIG. 3, by gesture control system 400 as described above in reference to FIG. 4, and/or by gesture control system 500 as described above in reference to FIG. 5.

As shown in FIG. 6, the method of flowchart 600 begins at step 602, in which a symbol gesture representation is received. The symbol gesture representation comprises at least one of an alpha-numeric representation, a punctuation representation, a geometric symbol representation, a geometric shape representation, or an extended character representation. This step may be performed, for example, by receiving logic such as receiving logic 304 of FIGS. 3, 4, and 5. Receiving logic 304 may be implemented and/or invoked in set top box 102 and/or controller(s) 104. Furthermore, receiving logic 304 may include an instance of API 108 in embodiments.

At step 604, the symbol gesture representation is translated into a multi-media device command. This step may be performed, for example, by translation logic such as translation logic 308 of FIGS. 3, 4, and 5. Translation logic 308 may be implemented and/or invoked in set top box 102 and/or controller(s) 104.

In embodiments, a lookup table or database may be used to translate the one or more control gesture representations into commands. The lookup table or database may be stored locally, e.g., in any modules and/or devices described above or in exemplary processor-based computer system 700 described below. In some embodiments, the lookup table or database may be stored remotely on a network or on the Internet (e.g., in cloud network 112).

At step 606, the multi-media device command is provided to a multi-media device. This step may be performed, for example, by output logic such as output logic 310 of FIGS. 3, 4, and 5. Output logic 310 may be implemented and/or invoked in set top box 102 and/or controller(s) 104.

In one embodiment, step 606 comprises providing the multi-media device command from controller(s) 104 to set top box 102. In another embodiment, step 606 comprises providing the multi-media device command from set top box 102 to one or more of multi-media device(s) 106, additional multi-media device(s) 106_{1-N}, and/or modules, devices, and/or services in cloud network 112. In yet another embodiment, step 606 comprises providing the multi-media device command from controller(s) 104 to one or more of multi-media device(s) 106, additional multi-media device(s) 106_{1-N}, and/or modules, devices, and/or services in cloud network 112.

The method of flowchart 600 may further include the multi-media device command comprising at least one of a channel command that causes the multi-media device to display multi-media content of a specified channel, wherein the symbol gesture representation indicates a channel designation for the specified channel, or a mode command that causes the multi-media device to operate in a designated mode.

In embodiments, the multi-media device command comprises at least one of a channel command that causes the multi-media device to display information associated with content of a specified channel, wherein the symbol gesture representation indicates a channel designation for the specified channel, a menu command that causes the multi-media device to enter a specified menu and display information associated with the specified menu, or a mode command that causes the multi-media device to operate in a designated mode.

In embodiments, the symbol gesture representation corresponds to a power command, and the multi-media device may be in one of a power-up mode or a power-down mode. The power command is a power-down command that causes the multi-media device to enter a power-down mode when in the power-up mode, and the power command is a power-up command that causes the multi-media device to enter a power-up mode when in the power-down mode.

### VII. Example Processor-Based System Implementation

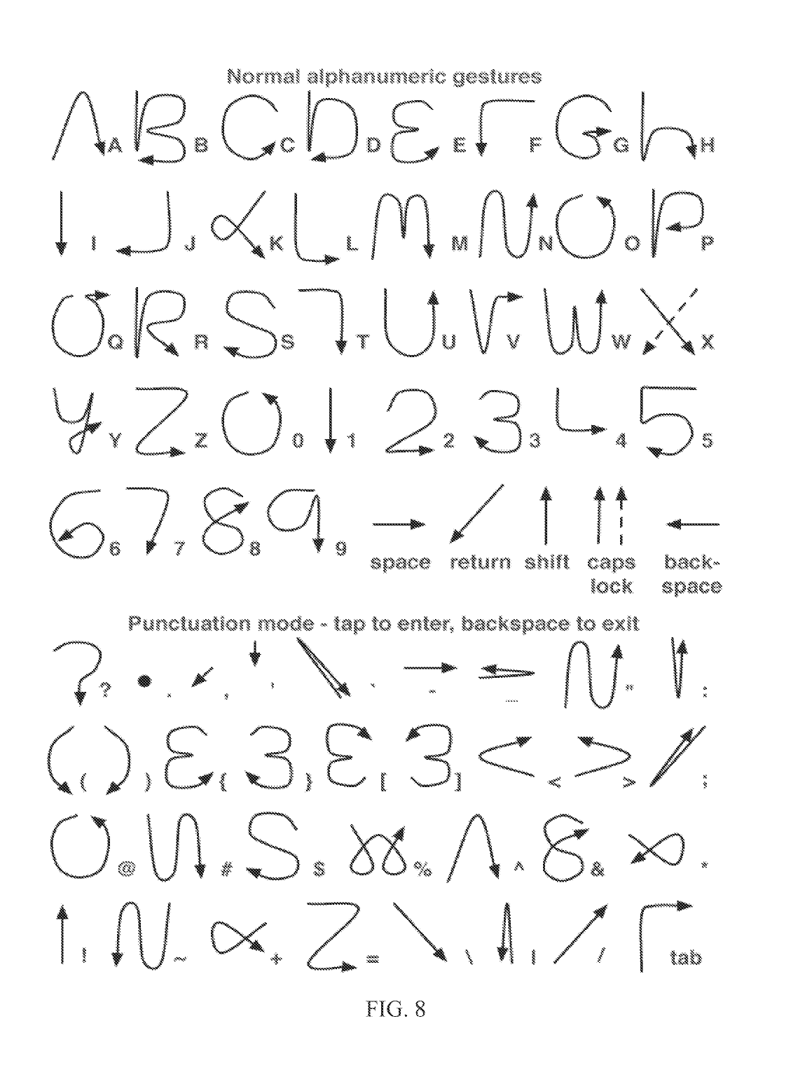

FIG. 7 depicts an example processor-based computer system 700 that may be used to implement various embodiments described herein. For example, system 700 may be used to implement set top box 102, controller(s) 104, and/or API 108 as described above in reference to FIGS. 1, 4, and 5, as well as any components thereof, and may be used to implement gesture control system 300 as described above in reference to FIG. 3, as well as any components thereof. The description of system 700 provided herein is provided for purposes of illustration, and is not intended to be limiting. Embodiments may be implemented in further types of computer systems, as would be known to persons skilled in the relevant art(s).

As shown in FIG. 7, system 700 includes a processing unit 702, a system memory 704, and a bus 706 that couples various system components including system memory 704 to processing unit 702. Processing unit 702 may comprise one or more processors or processing cores. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

System 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, BLU-RAY™ disk or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 730, one or more application programs 732, other program modules 734, and program data 736. In accordance with various embodiments, the program modules may include computer program logic that is executable by processing unit 702 to perform any or all of the functions and features of set top box 102, controller(s) 104, and/or API 108 as described above in reference to FIG. 1, as well as any components thereof, and may be used to implement gesture control system 300 as described above in reference to FIG. 3, as well as any components thereof, such as operating mode logic 302, receiving logic 304, determination logic 306, translation logic 308, and output logic 310. The program modules may also include computer program logic that, when executed by processing unit 702, performs any of the steps or operations shown or described in reference to the flowchart of FIG. 6.

A user may enter commands and information into system 700 through input devices such as a keyboard 738 and a pointing device 740. Other input devices (not shown) may include a microphone, joystick, game controller, scanner, or the like. In one embodiment, a touch screen is provided in conjunction with a display 744 to allow a user to provide user input via the application of a touch (as by a finger or stylus for example) to one or more points on the touch screen. These and other input devices are often connected to processing unit 702 through a serial port interface 742 that is coupled to bus 706, but may be connected by other interfaces, such as a parallel port, game port, or a universal serial bus (USB).

A display 744 is also connected to bus 706 via an interface, such as a video adapter 746. In addition to display 744, system 700 may include other peripheral output devices (not shown) such as speakers and printers.

System 700 is connected to a network 748 (e.g., a local area network or wide area network such as the Internet or the cloud) through a network interface or adapter 750, a modem 752, or other suitable means for establishing communications over the network. Modem 752, which may be internal or external, is connected to bus 706 via serial port interface 742.

As used herein, the terms “computer program medium,” “computer-readable medium,” and “computer-readable storage medium” are used to generally refer to storage devices or storage structures such as the hard disk associated with hard disk drive 714, removable magnetic disk 718, removable optical disk 722, as well as other storage device or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 732 and other program modules 734) may be stored on the hard disk, magnetic disk, optical disk, ROM, or RAM. Such computer programs may also be received via network interface 750, serial port interface 742, or any other interface type. Such computer programs, when executed or loaded by an application, enable computer 700 to implement features of embodiments of the present invention discussed herein. Accordingly, such computer programs represent controllers of the computer 700.

Embodiments are also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, any of set top box 102, controller(s) 104, and/or API 108 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### VIII. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
receiving a symbol gesture representation from an input interface of a controller, the symbol gesture representation comprising at least one of an alpha-numeric representation, a punctuation representation, a geometric symbol representation, a geometric shape representation, and an extended character representation;
translating the symbol gesture representation into a multi-media device command; and
providing the multi-media device command to a multi-media device.

2. The method of claim 1, wherein one or more of receiving the symbol gesture representation, translating the symbol gesture representation, and providing the multi-media device command are performed by the controller, by a set top box, or partially by the controller and partially by the set top box.

3. The method of claim 1, wherein the symbol gesture representation is normalized to represent a command across a plurality of different multi-media devices, services, applications, channels and/or content providers.

4. The method of claim 1, wherein providing the multi-media device command comprises:
providing the multi-media device command from the controller.

5. The method of claim 1, wherein receiving the symbol gesture representation comprises receiving the symbol gesture representation by a set top box via an application programming interface (API).

6. The method of claim 1, wherein the multi-media device command comprises at least one of:
a channel command that causes the multi-media device to display multi-media content of a specified channel, wherein the symbol gesture representation indicates a channel designation for the specified channel; or
a mode command that causes the multi-media device to operate in a designated mode.

7. The method of claim 1, wherein the multi-media device command comprises at least one of:
a channel command that causes the multi-media device to display information associated with content of a specified channel, wherein the symbol gesture representation indicates a channel designation for the specified channel;
a menu command that causes the multi-media device to enter a specified menu and display information associated with the specified menu; or
a mode command that causes the multi-media device to operate in a designated mode.

8. The method of claim 1, wherein the symbol gesture representation corresponds to a power command;
wherein the multi-media device is in one of a power-up mode or a power-down mode; and
wherein the power command causes the multi-media device to enter a power-down mode when in the power-up mode and that causes the multi-media device to enter a power-up mode when in the power-down mode.

9. A system that comprises:
receiving logic configured to receive a symbol gesture representation from an input interface of a controller, the symbol gesture representation comprising at least one of an alpha-numeric representation, a punctuation representation, a geometric symbol representation, a geometric shape representation, or an extended character representation;
translation logic configured to translate the symbol gesture representation into a multi-media device command; and
output logic configured to provide the multi-media device command to the multi-media device.

10. The system of claim 9, wherein one or more of the receiving logic, the translation logic, and the output logic are implemented by the controller, by a set top box, or partially by the controller and partially by the set top box.

11. The system of claim 9, wherein the symbol gesture representation is normalized to represent a command across a plurality of different multi-media devices, services, applications, channels and/or content providers.

12. The system of claim 9, wherein the output logic is located in the controller, and is configured to provide the multi-media device command by transmitting the multi-media device command from the controller to the multi-media device.

13. The system of claim 9, wherein the receiving logic is located in a set top box, and includes an application programming interface (API) by which the symbol gesture representation is received.

14. The system of claim 9, wherein the multi-media device command comprises at least one of:
a channel command that causes the multi-media device to display multi-media content of a specified channel, wherein the symbol gesture representation indicates a channel designation for the specified channel; or
a mode command that causes the multi-media device to operate in a designated mode.

15. The system of claim 9, wherein the multi-media device command comprises at least one of:
a channel command that causes the multi-media device to display information associated with content of a specified channel, wherein the symbol gesture representation indicates a channel designation for the specified channel; a menu command that causes the multi-media device to enter a specified menu and display information associated with the specified menu; or
a mode command that causes the multi-media device to operate in a designated mode.

16. The system of claim 9, wherein the symbol gesture representation corresponds to a power command;
wherein the multi-media device is in one of a power-up mode or a power-down mode; and
wherein the power command causes the multi-media device to enter a power-down mode when in the power-up mode and causes the multi-media device to enter a power-up mode when in the power-down mode.

17. A system that comprises:
a multi-media device;
a set top box communicatively coupled to the multi-media device, the set top box configured to
obtain information indicative of an operating mode of the multi-media device; and
a controller communicatively coupled to the set top box, the controller comprising an application programming interface (API), and being configured to:
receive the information from the set top box using the API;
accept a symbol gesture input associated with a first command of a first operating mode of the multi-media device and associated with a second command of a second operating mode of the multi-media device, the symbol gesture input comprising at least one of an alpha-numeric representation, a punctuation representation, a geometric symbol representation, a geometric shape representation, or an extended character representation;
determine that the multi-media device is operating in the first operating mode based on the received information;
translate the symbol gesture input into the first command for controlling the multi-media device based at least on the determining that the multi-media device is operating in the first operating mode; and
output the first command for controlling the multi-media device.

18. The system of claim 17, wherein the first mode is a playback mode, and wherein the first command comprises at least one of:
a channel command that causes the multi-media device to display multi-media content of a specified channel, wherein the symbol gesture input indicates a channel designation for the specified channel; or
a mode command that causes the multi-media device to operate in a designated mode.

19. The system of claim 17, wherein the first mode is a navigation mode, and wherein the first command comprises at least one of:
a channel command that causes the multi-media device to display information associated with content of a specified channel, wherein the symbol gesture input indicates a channel designation for the specified channel;
a menu command that causes the multi-media device to enter a specified menu and display information associated with the specified menu;
a mode command that causes the multi-media device to operate in a designated mode.

20. The system of claim 17, wherein the symbol gesture input corresponds to a power command;
wherein the first mode is one of a power-up mode or a power-down mode; and
wherein the power command causes the multi-media device to enter a power-down mode when the first mode is the power-up mode and causes the multi-media device to enter a power-up mode when the first mode is the power-down mode.
